(19) United States
(12) Patent Application Publication
(10) Pub. No.: US 2021/0107521 A1
(43) Pub. Date: Apr. 15, 2021

(54) VEHICLE CONTROL SYSTEM

(71) Applicant: Toyota Jidosha Kabushiki Kaisha, Toyota-shi (JP)

(72) Inventors: Kazuyuki Fujita, Gotemba-shi (JP); Yoshinori Watanabe, Isehara-shi (JP); Takayuki Goto, Yokohama-shi (JP); Masahiro Harada, Hadano-shi (JP); Nobuhide Kamata, Susono-shi (JP)

(21) Appl. No.: 17/068,001

(22) Filed: Oct. 12, 2020

(30) Foreign Application Priority Data
Oct. 15, 2019 (JP) 2019-188900

(51) Int. Cl. B60W 60/00; B60W 30/095; B60W 40/09

(52) U.S. Cl. CPC B60W 60/0015; B60W 30/0953; B60W 2540/229; B60W 40/09; B60W 30/0956

(57) ABSTRACT

The vehicle control system includes a first unit configured to generate a target trajectory for the automated driving, and a second unit configured to execute vehicle travel control such that the vehicle follows the target trajectory. During the automated driving, the second unit is configured to control a travel control amount of the vehicle travel control, acquire driving environment information, and perform preventive safety control for intervening in the travel control amount so as to prevent or avoid a collision between the vehicle and an obstacle based on the driving environment information. In the preventive safety control, the second unit is configured to acquire a driving involvement degree indicating a degree of involvement of a person in driving of the vehicle, and to change an intervention degree to the travel control amount in the preventive safety control based on the driving involvement degree.

### CROSS-REFERENCE TO RELATED APPLICATION

The present application is based on, and claims priority from, Japanese Patent Application Serial Number 2019-188900, filed Oct. 15, 2019, the disclosure of which is hereby incorporated by reference herein in its entirety.

### BACKGROUND

### Field

The present disclosure relates to a vehicle control system that controls a vehicle performing automated driving.

### Background

JP 2014-106854A discloses a technique related to an automated driving control device for performing automated driving of a vehicle. In this technique, it is determined whether a condition for performing automated driving is satisfied based on the detection accuracy of detection means for acquiring at least one of a travel state of the vehicle, a peripheral state of the vehicle, and a state of a driver. When it is determined that the condition for performing the automated driving is not satisfied, control is performed such as to notify the driver to cancel the automated driving.

JP 2006-1369A discloses a technique related to a Pre-Crash Safety system (PCS). The pre-crash safety system of this technique realizes the function of judging the situation of the own vehicle in which a collision is unavoidable in advance and activating safety equipment early to reduce the collision damage.

### SUMMARY

During automated driving of a vehicle, a target trajectory is generated by an automated driving system that manages automated driving. The vehicle performs vehicle travel control that controls steering, acceleration and deceleration to follow the generated target trajectory.

Here, as in the above pre-crash safety system, consider a case where the preventive safety control to perform the intervention to the control amount of the vehicle travel control by determining the driving environment around the vehicle in advance is performed during the automated driving of the vehicle. Although preventive safety control is a control that contributes to safety, excessive intervention may cause the occupants (driver) to feel uncomfortable or uneasy. Such an occupant's sensation varies with the degree to which the occupant is involved in current driving of the vehicle. For this reason, preventive safety control during automated driving has room for further optimization from the viewpoint of the degree of occupant's involvement in driving.

The present disclosure has been made in view of the above-mentioned problems, and an object thereof is to provide a vehicle control system capable of optimizing preventive safety control according to the degree of involvement of a passenger in driving.

In order to solve the above problems, the first disclosure is applied to a vehicle control system that controls a vehicle capable of performing automated driving. The vehicle control system includes a first unit configured to generate a target trajectory for the automated driving based on a travel plan of the vehicle, and a second unit configured to execute vehicle travel control that controls steering, acceleration, and deceleration of the vehicle such that the vehicle follows the target trajectory. During the automated driving, the second unit is configured to control a travel control amount which is a control amount of the vehicle travel control, acquire driving environment information indicating a driving environment around the vehicle, and perform preventive safety control for intervening in the travel control amount so as to prevent or avoid a collision between the vehicle and an obstacle based on the driving environment information. In the preventive safety control, the second unit is configured to acquire a driving involvement degree indicating a degree of involvement of a person in driving of the vehicle, and to change an intervention degree to the travel control amount in the preventive safety control based on the driving involvement degree.

The second disclosure has the following further features in the first disclosure.

In the preventive safety control, when the driving involvement degree is low, the second unit is configured to change the intervention degree so as to accelerate an operation timing of the preventive safety control as compared with a case where the driving involvement degree is high.

The third disclosure has the following further features in the first disclosure.

The first unit is configured to calculate the driving involvement degree based on automated driving information related to the automated driving, and transmit the driving involvement degree to the second unit.

The fourth disclosure has the following further features in the third disclosure.

The automated driving information includes whether the target trajectory is generated. The first unit is configured to calculate the driving involvement degree as a lower value when the target trajectory is generated than when the target trajectory is not generated.

The fifth disclosure has the following further features in the third disclosure.

The automated driving information includes an operation amount of the travel device of the vehicle by a person. The first unit is configured to calculate the driving involvement degree based on the operation amount.

The sixth disclosure has the following further features in the first disclosure.

The first unit is configured to transmit automated driving information related to the automated driving to the second unit. The second unit is configured to calculate the driving involvement degree based on the automated driving information acquired from the first unit.

The seventh disclosure has the following further features in the sixth disclosure.

The automated driving information includes the target trajectory. The second unit is configured to calculate the driving involvement degree as a higher value when the received target trajectory is an invalid value than when the target trajectory is a valid value.

The eighth disclosure has the following further features in the sixth disclosure.

The automated driving information includes the target trajectory. The second unit is configured to calculate the driving involvement degree based on a degree of agreement between the received target trajectory and a current behavior of the vehicle.

According to the vehicle control system in accordance with the present disclosure, the second unit may grasp the driving involvement degree indicating the degree of involvement of the driver with respect to the driving of the vehicle. As the driving involvement degree changes, the performance required for preventive safety control changes accordingly. Therefore, according to the present disclosure, the second unit may determine the intervention degree of the preventive safety control in consideration of the driving involvement degree. This makes it possible to suppress the sense of discomfort and anxiety of the occupant, and to secure high safety.

### BRIEF DESCRIPTION OF DRAWINGS

FIG. 1 is a block diagram showing a configuration example for explaining an outline of a vehicle control system according to first embodiment;

FIG. 2 is a diagram schematically showing an example of an operating condition satisfied area;

FIG. 3 is a diagram showing a state in which a preceding vehicle V1 of a vehicle M1 is turned left;

FIG. 4 is a diagram showing an example of an operation timing of a preventive safety control when a preceding vehicle turns left;

FIG. 5 is a block diagram showing a configuration example of a first unit according to the first embodiment;

FIG. 6 is a flowchart showing a control routine of a target trajectory generation process executed in a first controller of the first unit according to the first embodiment;

FIG. 7 is a block diagram showing a configuration example of a second unit according to the first embodiment;

FIG. 8 is a flowchart showing a routine of processing relating to a pre-crash safety control executed in a second controller according to the first embodiment;

FIG. 9 is a flowchart showing a control routine of the intervention degree change control executed in the second controller according to the first embodiment; and

FIG. 10 is a diagram showing a modification of the configuration of the vehicle control system according to the first embodiment.

### DETAILED DESCRIPTION

Hereinafter, an embodiment of the present disclosure will be described with reference to the accompanying drawings. However, it is to be understood that even when the number, quantity, amount, range or other numerical attribute of each element is mentioned in the following description of the embodiment, the present disclosure is not limited to the mentioned numerical attribute unless explicitly described otherwise, or unless the present disclosure is explicitly specified by the numerical attribute theoretically. Furthermore, structures or steps or the like that are described in conjunction with the following embodiment is not necessarily essential to the present disclosure unless explicitly described otherwise, or unless the present disclosure is explicitly specified by the structures, steps or the like theoretically.

### 1. First Embodiment

### 1-1. Overall Configuration of Vehicle Control System According to First Embodiment

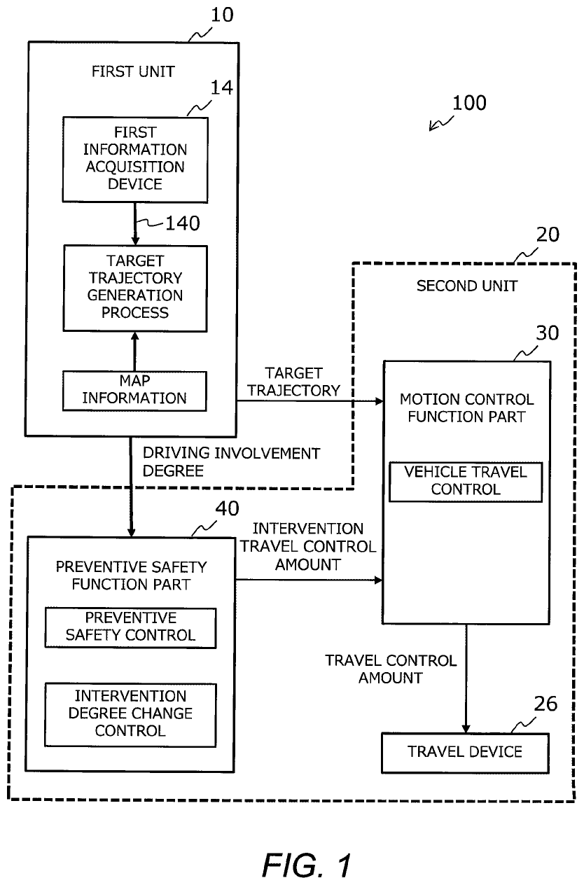

First, a schematic configuration of a vehicle control system according to the present embodiment will be described. FIG. 1 is a block diagram showing a configuration example for explaining an outline of the vehicle control system according to the first embodiment. A vehicle control system 100 shown in FIG. 1 is mounted on a vehicle. Hereinafter, the vehicle in which the vehicle control system 100 is mounted is also referred to as a vehicle M1. The vehicle M1 is a vehicle with an automated driving function capable of performing automated driving by the vehicle control system 100 in addition to manual driving by a driver. As the automated driving in this case, automated driving of level 3 or higher in the level definition of SAE (Society of Automotive Engineers) is assumed. A power source of the vehicle M1 is not limited.

The vehicle control system 100 controls the vehicle M1. Alternatively, at least a portion of the vehicle control system 100 may be located on an external device external to the vehicle and remotely control the vehicle. That is, the vehicle control system 100 may be distributed to the vehicle M1 and the external device.

As shown in FIG. 1, the vehicle control system 100 is configured to include a first unit 10 and a second unit 20. The first unit 10 is an automated driving system for managing the automated driving of the vehicle M1. The second unit 20 is a vehicle traveling system for performing a vehicle traveling control of the vehicle M1. The first unit 10 and the second unit 20 may be physically separate devices or may be the same device. If the first unit 10 and the second unit 20 are physically separate devices, they exchange necessary information via communications. The functions of these systems will be described below.

The first unit 10 includes a first information acquisition device 14. The first information acquisition device 14 acquires various information using sensors mounted on the vehicle M1. Information acquired by the sensors mounted on the vehicle M1 is information indicating a driving environment of the vehicle M1. In the following description, this information is referred to as “driving environment information 140”. The driving environment information 140 includes vehicle position information indicating a position of the vehicle M1, vehicle state information indicating a state of the vehicle M1, surrounding situation information indicating a surrounding situation of the vehicle M1, driver information indicating a state of a driver of the vehicle M1, and the like.

The first unit 10 has a function for executing a target trajectory generation process. In the target trajectory generation process, map information is used. The map information includes various information associated with the position. The map information is not limited to general road maps and navigation maps, and may include map information of various viewpoints. For example, the map information may include the position of a stationary object on a road, such as a guardrail, or a wall, a road surface, a white line, a pole, or a characteristic object such as a signboard.

The first unit 10 generates a travel plan of the vehicle M1 during the automated driving, based on the map information and the driving environment information 140. The travel plan includes maintaining a current travel lane, making a lane change, avoiding obstacles, overtaking a preceding vehicle, stopping by shifting to a road shoulder, and so forth. Then, the first unit 10 generates the target trajectory required for the vehicle M1 to travel in accordance with the travel plan.

Here, the target trajectory includes a set of target positions [Xi, Yi] of the vehicle M1 in a road on which the vehicle M1 travels. Incidentally, an X-direction is a forward direction of the vehicle M1, and a Y-direction is a plane direction orthogonal to the X-direction. The target trajectory may further include a target velocity [VXi, VXi] for each target position [Xi, Yi]. The first unit 10 outputs the generated target trajectory to the second unit 20.

The second unit 20 includes a motion control function part 30 for performing vehicle travel control of the vehicle M1. In the vehicle travel control, the motion control function part 30 controls the control amount related to steering, acceleration, and deceleration of the vehicle M1. Their control amounts are hereinafter referred to as “travel control amount”. During the automated driving of the vehicle M1, the motion control function part 30 of the second unit 20 receives the target trajectory from the first unit 10. Basically, the motion control function part 30 controls the travel control amount of the vehicle M1 so that the vehicle M1 follows the target trajectory. Typically, the motion control function part 30 calculates the deviation between various state quantities of the vehicle M1 and the target trajectory (e.g., lateral deviation, yaw angle deviation, velocity deviation, and so forth). Then, the motion control function part 30 calculates the travel control amount such that the deviation decreases.

The calculated travel control amount is output to a travel device 26. The travel device 26 includes a device for driving, braking, and turning the vehicle M1. The travel device 26 controls the traveling of the vehicle M1 based on the input travel control amount.

The second unit 20 further includes a preventive safety function part 40 for performing preventive safety control of the vehicle M1. In the preventive safety control, the preventive safety function part 40 intervenes in the vehicle control amount of the vehicle M1 for the purpose of preventing, avoiding, or reducing the collision between the vehicle M1 and obstacles. As such preventive safety control, for example, a Pre-Crash Safety (PCS) control is exemplified. The pre-crash safety control supports the avoidance of collision between the vehicle M1 and a surrounding object to be avoided (namely, an avoidance target). The preventive safety control also includes risk avoidance control for controlling the vehicle control amount of the vehicle M1 at a timing faster than the Pre-Crash Safety (PCS) control in preparation for a possible risk in the future.

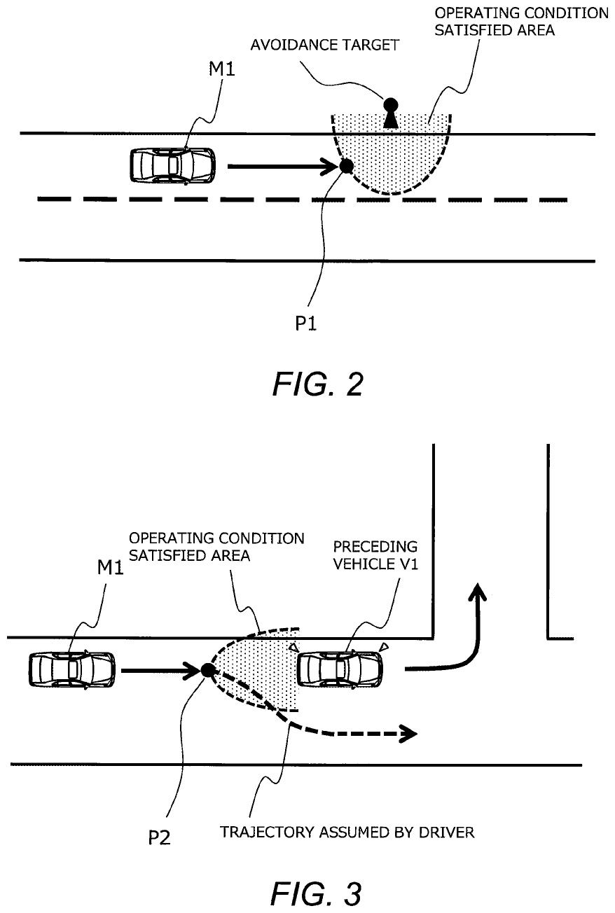

In the pre-crash safety control, the preventive safety function part 40, based on the driving environment information indicating the driving environment of the vehicle M1, determines whether an operating condition of the pre-crash safety control is satisfied. Here, for example, the operating condition is that a TTC (Time To Collision) from the vehicle M1 to the avoidance target is smaller than a predetermined threshold value. FIG. 2 is a diagram schematically showing an example of an operating condition satisfied area. In the example shown in FIG. 2, when the vehicle M1 enters an operating condition satisfied area at the position P1, the preventive safety function part 40 calculates a travel control amount for avoiding a collision to the avoidance target. The travel control amount calculated by the preventive safety function part 40 is hereinafter referred to as an “intervention travel control amount”. The calculated intervention travel control amount is output to the motion control function part 30.

Basically, the motion control function part 30 calculates the travel control amount of the vehicle M1 so that the vehicle M1 follows the target trajectory. However, when the intervention travel control amount is input from the preventive safety function part 40, the motion control function part 30 outputs the input intervention travel control amount to the travel device 26.

### 1-2. Features of Vehicle Control System of First Embodiment

Next, the features of the vehicle control system of the present embodiment will be described. As an example, FIG. 3 shows a situation where the preceding vehicle V1 of the vehicle M1 turns to the left. If the vehicle M1 is traveling by manual driving, for example, the driver may recognize the display of the direction indicator of the preceding vehicle V1 to grasp the intention of the left turn of the preceding vehicle V1. In such a situation, the driver may approach the preceding vehicle V1 without decelerating more than necessary assuming that the preceding vehicle V1 will turn to the left. However, when the vehicle M1 approaches the preceding vehicle V1, for example, the operating condition of the preventive safety control is established at the position P2, and there is a possibility that intervention (e.g., deceleration) to the travel control amount is performed. If deceleration is performed which the driver considers unnecessary, the driver may feel uncomfortable or anxious.

On the other hand, if the vehicle M1 is traveling by automated driving, even if the intervention to the travel control amount by the preventive safety control is performed, the driver on board the vehicle M1 does not feel a sense of discomfort or anxiety as much as the case where the driver takes the initiative in manual driving. This is because it is not an intervention for driving behavior of the driver. Therefore, when the automated driving of the vehicle M1 is being performed, for example, control for enhancing safety can be performed by suppressing the behavior change of the vehicle M1 by accelerating an operation timing of the preventive safety control.

Thus, in situations where the degree of involvement of the driver with respect to the operation is different, the performance required for preventive safety control is different. Therefore, in the vehicle control system 100 of the present embodiment, the degree to which the driver is involved in the operation of the vehicle M1 is used as an index to optimize the preventive safety control. In the following description, the degree of involvement of the driver in the automated driving is referred to as “driving involvement degree”. The driving involvement degree is determined from the following indices, for example.

When the vehicle M1 is traveling by manual driving, the driving involvement degree is higher than when it is traveling by automated driving. Further, when the automated driving of the vehicle M1 is being performed, the higher the realized automated driving level (e.g., the automated driving level of SAE) is, the lower the driving involvement degree is. When an override in which a driver temporarily performs an operation of steering, acceleration, or deceleration from the travel device 26 is performed during the automated driving of the vehicle M1, the driving involvement degree is higher than that of automated driving in which override is not performed. In addition, during the override of automated driving, the longer the elapsed time due to override, the higher the driving involvement degree. Further, when the frequency of override of automated driving is high, the driving involvement degree is higher than that when the frequency is low. When there is no passenger in the driver's seat during the automated driving, the driving involvement degree is lower than that when there is a passenger. When the driver's awareness of operation is low, that is, when the driver is looking aside or dozing, the driving involvement degree is lower than that when the driver's awareness of operation is high. The driving involvement degree may be a numerical value or a rank.

The driving involvement degree is calculated by the first unit 10 using information including the above-mentioned index, for example. Such information is hereinafter referred to as “automated driving information”. A driving involvement degree calculation process executed in the first unit 10 will be described in detail later. The driving involvement degree calculated in the first unit 10 is output to the second unit 20.

The preventive safety function part 40 of the second unit 20 changes the intervention degree of the preventive safety control based on the driving involvement degree. In the following description, this control is referred to as “intervention degree change control”. The intervention degree here is the degree of intervention of the preventive safety control with respect to the travel control amount calculated based on the target trajectory. The intervention degree can be controlled by changing the operating conditions of the preventive safety control (e.g., operating threshold, operation timing) and the amount of operation.

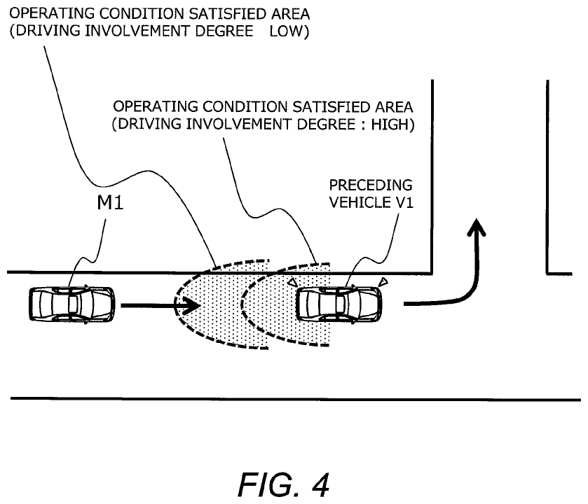

FIG. 4 is a diagram showing an example of the operation timing of the preventive safety control when a preceding vehicle turns left. For example, when the driving involvement degree is low, the preventive safety function part 40 changes the operating condition so that the operation timing of the preventive safety control becomes earlier than when the driving involvement degree is high.

As described above, when the driving involvement degree of the vehicle M1 is low, the preventive safety function part 40 changes the operating condition so that the operation timing of the preventive safety control becomes earlier than when the driving involvement degree is high, based on the driving involvement degree. Thus, while suppressing the operation of the preventive safety control in a situation where the driver easily feels unnecessary, in a situation where the driver is difficult to feel unnecessary, it is possible to suppress the variation of the vehicle behavior by the early operation of the preventive safety control to ensure safety.

Hereinafter, the detailed configuration and operation of the vehicle control system 100 according to the present embodiment will be described in more detail.

### 1-3. Detailed Configuration Example of First Unit 10

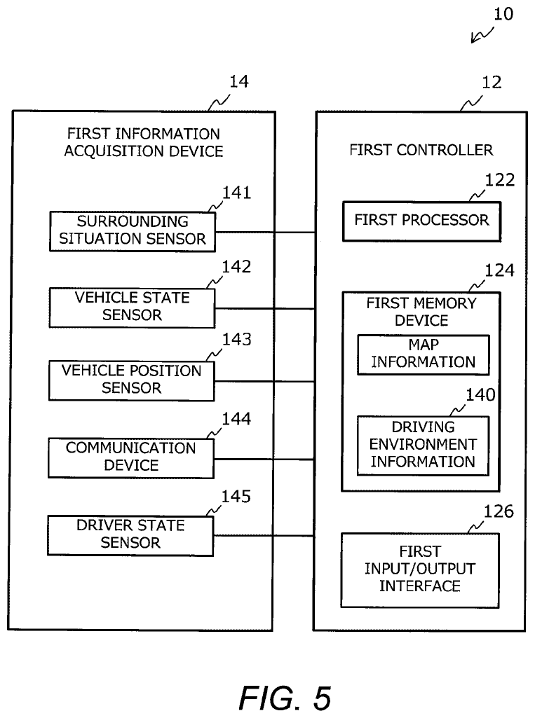

FIG. 5 is a block diagram showing a configuration example of the first unit according to the present embodiment. As shown in FIG. 5, the first unit 10 includes a first controller 12 for managing the automated driving of the vehicle M1. Further, the first unit 10 includes a first information acquisition device 14 connected to the input side of the first controller 12.

The first information acquisition device 14 includes a surrounding situation sensor 141, a vehicle state sensor 142, a vehicle position sensor 143, a communication device 144, and a driver state sensor 145.

The surrounding situation sensor 141 recognizes surrounding situation information of the vehicle M1. For example, the surrounding situation sensor 141 is exemplified a camera (imaging device), a LIDAR: Laser Imaging Detection and Ranging, a radar, and so forth. The surrounding situation information includes target information about a target recognized by the surrounding situation sensor 141. The target is exemplified by a surrounding vehicle, a pedestrian, a roadside structure, an obstacle, a white line, a signal, and the like. The target information includes information on a relative position and a relative velocity of the target with respect to the vehicle M1. The surrounding situation information recognized by the surrounding situation sensor 141 is transmitted to the first controller 12 at any time.

The vehicle state sensor 142 detects vehicle information indicating a state of the vehicle M1. For example, the vehicle state sensor 142 includes a vehicle speed sensor, a lateral acceleration sensor, a yaw rate sensor, and the like. The vehicle information detected by the vehicle state sensor 142 is transmitted to the first controller 12 at any time.

The vehicle position sensor 143 detects a position and an orientation of the vehicle M1. For example, the vehicle position sensor 143 includes a GPS (Global Positioning System) sensor. The GPS sensor receives a signal transmitted from a plurality of GPS satellites, and calculates the position and the orientation of the vehicle M1 based on the received signal. The vehicle position sensor 143 may perform well-known self-position estimation process (localization) to increase accuracy of the present position of the vehicle M1. The vehicle information detected by the vehicle position sensor 143 is transmitted to the first controller 12 at any time.

The communication device 144 communicates with the outside of the vehicle. For example, the communication device 144 communicates with an external device outside of the vehicle M1 via a communication network. For example, the external device includes a roadside unit, a surrounding vehicle, a surrounding infrastructure, and the like. The roadside unit is a beacon device that transmits, for example, traffic jam information, traffic information by lane, restriction information such as pause, information on traffic conditions at blind spot positions, and the like. Further, when the external device is a surrounding vehicle, the communication device 144 performs vehicle to-to-vehicle communication (V2V communication) with the surrounding vehicle. Further, when the external device is a surrounding infrastructure, the communication device 144 performs vehicle-to-infrastructure communication (V2I communication) with the surrounding infrastructure.

The driver state sensor 145 detects an index of a consciousness level for a driving of the driver driving the vehicle M1. The index of the consciousness level of the driver detected here is, for example, a line of sight, a heartbeat state, a breathing state, or the like. The line of sight of the driver is grasped, for example, by observing the line of sight of the driver by a camera installed in the vehicle. The heartbeat state of the driver is grasped by detecting the heartbeat rate of the driver holding the steering wheel, for example, by an electrode incorporated in the steering wheel. Further, the breathing state of the driver is grasped by observing a change in the detection value of a load sensor incorporated in a seat on which the driver is seated. The method of detecting the driver's consciousness level is not particularly limited, and may be any method as long as it is an index capable of determining the driving involvement degree in a driving involvement degree calculation process described later.

The first controller 12 is an information processing device that perform various processes in the vehicle control system 100. More specifically, the first controller 12 is a microcomputer having a first processor 122, a first memory device 124, and a first input/output interface 126. The first controller 12 is also referred to as an Electronic Control Unit (ECU).

Various kinds of information are stored in the first memory device 124. For example, the driving environment information 140 acquired by the first information acquisition device 14 is stored in the first memory device 124. For example, the first memory device 124 includes a volatile memory, a non-volatile memory, and a hard disk drive (HDD).

The first memory device 124 stores map information including detailed road information. The map information includes, for example, information on a shape of a road, a number of lanes, a lane width, and the like. Alternatively, the map information may be stored in an external management server. In this case, the first controller 12 communicates with the management server to acquire necessary map information. The acquired map information is stored in the first memory device 124.

The first processor 122 executes automated driving software which is a computer program. The automated driving software is stored in the first memory device 124. Alternatively, the automated driving software is recorded on a computer-readable recording medium. The functions of the first controller 12 is realized by the first processor 122 executing the automated driving software.

The first controller 12 performs management of the automated driving of the vehicle M1. Typically, the first controller 12 performs a target trajectory generation process for generating a target trajectory for the automated driving of the vehicle M1.

The first input/output interface 126 is an interface for exchanging information with the second unit 20. The automated driving information and the target trajectory generated by the first controller 12 are output to the second unit 20 via the first input/output interface 126.

### 1-4. Target Trajectory Generation Process

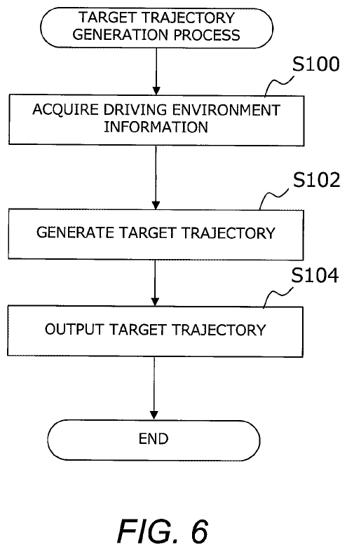

FIG. 6 is a flowchart showing a control routine of a target trajectory generation process executed in the first controller of the first unit according to the present embodiment. The control routine shown in FIG. 6 is repeatedly executed at a predetermined control period during the automated driving of the vehicle M1.

In the control routine shown in FIG. 6, first in step S100, the first controller 12 acquires the driving environment information 140 from the first information acquisition device 14. The driving environment information 140 is stored in the first memory device 124.

Next in step S102, the first controller 12 generates a target trajectory for the automated driving of the vehicle M1 based on the map information and the driving environment information 140. More specifically, the first controller 12 generates a travel plan of the vehicle M1 during the automated driving, based on the map information and the driving environment information 140. The first controller 12 generates the target trajectory required for the vehicle M1 to travel according to the generated travel plan based on the driving environment information 140.

For example, the first controller 12 generates a target trajectory for the passing of a preceding vehicle. More specifically, the first controller 12 recognizes the preceding vehicle based on the surrounding situation information. Furthermore, the first controller 12 predicts the future position of each of the vehicle M1 and the preceding vehicle based on the vehicle state information and the surrounding situation information, and generates a target trajectory for the vehicle M1 to avoid and overtake the preceding vehicle.

As another example, the first controller 12 generates the target trajectory for moving the vehicle M1 to a shoulder. More specifically, the first controller 12 recognizes the road shoulder, which is a destination, and the surrounding people and structures of the shoulder, based on the map information, the vehicle position information, and the surrounding situation information. Then, the first controller 12 generates the target trajectory for the vehicle M1 to avoid the surrounding people and structures and to stop the shoulder based on the information.

The first controller 12 outputs the generated target trajectory to the second unit 20 via the first input/output interface 126 in step S104. Each time the target trajectory is updated, the latest target trajectory is output to the second unit 20.

### 1-5. Detailed Configuration Example of Second Unit 20

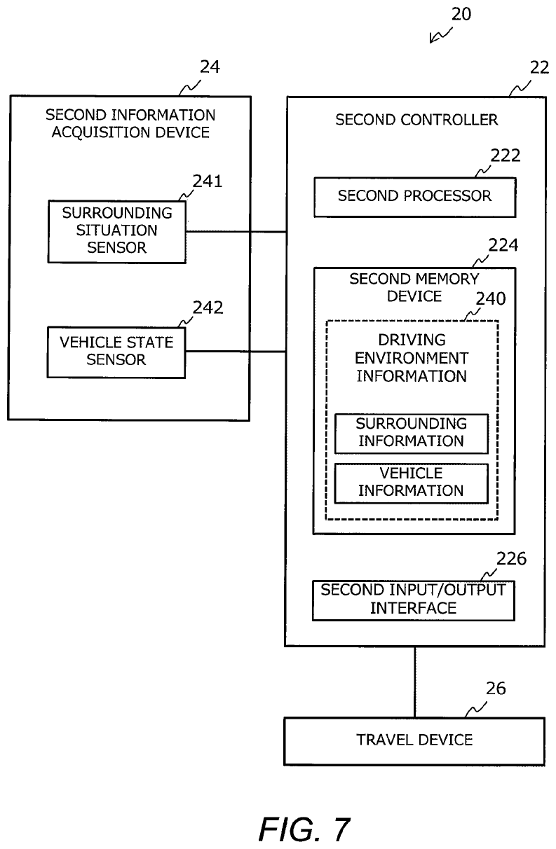

FIG. 7 is a block diagram showing a configuration example of the second unit according to the present embodiment. As shown in FIG. 7, the second unit 20 includes a second controller 22, a second information acquisition device 24, and a travel device 26.

The second information acquisition device 24 includes a surrounding situation sensor 241 and a vehicle state sensor 242.

The surrounding situation sensor 241 recognizes surrounding situation information of the vehicle M1. For example, the surrounding situation sensor 241 is exemplified a camera (imaging device), a LIDAR: Laser Imaging Detection and Ranging, a radar, and so forth. The surrounding situation information includes target information about a target recognized by the surrounding situation sensor 241. The target is exemplified by a surrounding vehicle, a pedestrian, a roadside structure, an obstacle, a white line, a signal, and the like. The target information includes information on a relative position and a relative velocity of the target with respect to the vehicle M1. The surrounding situation information recognized by the surrounding situation sensor 241 is transmitted to the second controller 22 at any time.

The vehicle state sensor 242 detects vehicle information indicating a state of the vehicle M1. For example, the vehicle state sensor 242 includes a vehicle speed sensor, a lateral acceleration sensor, a yaw rate sensor, and the like. The vehicle information detected by the vehicle state sensor 242 is transmitted to the second controller 22 at any time. In the following description, the surrounding situation information and the vehicle information acquired by the second information acquisition device 24 are referred to as “driving environment information 240”.

The first information acquisition device 14 and the second information acquisition device 24 may be partially shared. For example, the surrounding situation sensor 141 and the surrounding situation sensor 241 may be common. The vehicle state sensor 142 and the vehicle state sensor 242 may be common. That is, the first unit 10 and the second unit 20 may share a part of the first information acquisition device 14 or the second information acquisition device 24. In this case, the first unit 10 and the second unit 20 exchange necessary information with each other.

In addition to the surrounding situation sensor 241 and the vehicle state sensor 242, the second information acquisition device 24 may further include the same devices as the vehicle position sensor 143, the communication device 144, or the driver state sensor 145.

The travel device 26 includes a steering device, a driving device, and a braking device. The steering device turns wheels of the vehicle M1. The driving device is a power source that generates a driving force of the vehicle M1. The driving device is exemplified by an engine or an electric motor. The braking device generates a braking force of the vehicle M1.

The second controller 22 is an information processing device that perform various processes in the vehicle control system 100. More specifically, the second controller 22 is a microcomputer having a second processor 222, a second memory device 224, and a second input/output interface 226. The second controller 22 is also referred to as an Electronic Control Unit.

Various kinds of information are stored in the second memory device 224. For example, the second memory device 224 stores the surrounding situation information and the vehicle information (driving environment information 240) acquired by the second information acquisition device 24. For example, the second memory device 224 includes a volatile memory, a non-volatile memory, and a hard disk drive (HDD).

The second processor 222 executes vehicle travel control software which is a computer program. The vehicle travel control software is stored in the second memory device 224. Alternatively, the vehicle travel control software is recorded on a computer-readable recording medium. The function of the second controller 22 is realized by the second processor 222 executing the vehicle travel control software.

Specifically, the functions of the motion control function part 30 are realized by the second processor 222 executing the vehicle travel control software related to the vehicle travel control. In addition, the second processor 222 executes the vehicle travel control software related to the preventive safety control, thereby realizing the functions of the preventive safety function part 40. That is, the motion control function part 30 and the preventive safety function part 40 are incorporated in the second controller 22 as functions for performing the vehicle running control and the preventive safety control.

The motion control function part 30 and the preventive safety function part 40 may be incorporated in physically different controllers. In this case, the second unit 20 may be separately provided with a controller for the motion control function part 30 for performing vehicle travel control and a controller for the preventive safety function part 40 for performing preventive safety control.

The second input/output interface 226 is an interface for exchanging information with the first unit 10. The target trajectory and the automated driving information output from the first controller 12 are input to the second unit 20 via the second input/output interface 226.

### 1-6. Vehicle Travel Control

The second controller 22 executes the “vehicle travel control” that control the steering, the acceleration, and the deceleration of the vehicle M1. The second controller 22 executes the vehicle travel control by controlling an operation of the travel device 26. Specifically, the second controller 22 controls the steering of the vehicle M1 by controlling an operation of the steering device. The second controller 22 also controls the acceleration of the vehicle M1 by controlling an operation of the driving device. The second controller 22 controls the deceleration of the vehicle M1 by controlling an operation of the braking device.

In the vehicle travel control, the second controller 22 receives the target trajectory from the first unit 10 during the automated driving of the vehicle M1. Basically, the second controller 22 controls the travel control amount of the vehicle M1 such that the vehicle M1 follows the target trajectory. Typically, the motion control function part 30 calculates a deviation between various state quantities of the vehicle M1 and the target trajectory (e.g., lateral deviation, yaw angle sensor, speed deviation, etc.). Then, the motion control function part 30 executes the vehicle running control such that the deviation decreases.

### 1-7. Preventive Safety Control

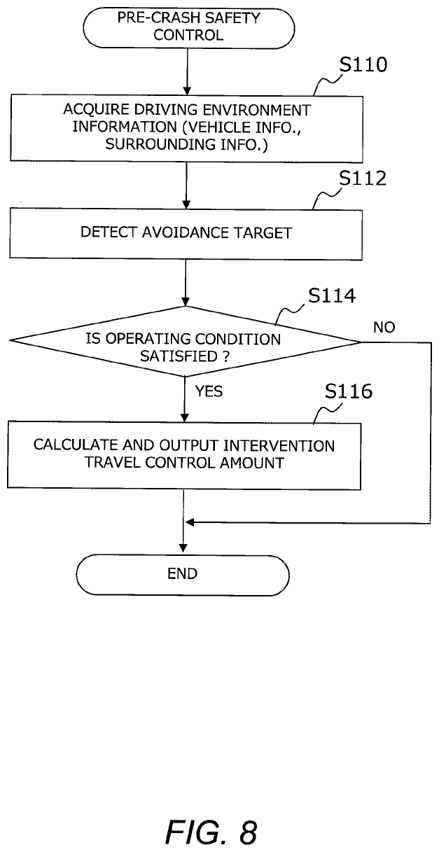

The second controller 22 performs preventive safety control to intervene in the travel control amount of the vehicle travel control for the purpose of improving the safety of the vehicle M1. Typically, the second controller 22 executes a pre-crash safety control to avoid a collision to the collision object of the vehicle M1 during the automated driving of the vehicle M1. FIG. 8 is a flowchart showing a routine of processing relating to the pre-crash safety control executed by the second controller 22. The second controller 22 repeatedly executes the routine shown in FIG. 8 at a predetermined control period during the automated driving of the vehicle M1.

When the routine shown in FIG. 8 is started, the second controller 22 acquires the driving environment information 240 from the second information acquisition device 24 in step S110. The acquired information is stored in the second memory device 224.

Next, in step S112, the second controller 22 detects the avoidance target based on the driving environment information 240. Next, in step S114, the second controller 22 determines whether the operating condition of the preventive safety control for the avoidance target is satisfied. Here, for example, the operating condition is that a TTC (Time To Collision) from the vehicle M1 to the avoidance target is smaller than a predetermined threshold value. As a result, when the operating condition is not satisfied, the processing of this routine is terminated. On the other hand, when the operating condition is satisfied, the second controller 22 calculates the intervention travel control amount for avoiding a collision to the avoidance target, in step S116. The calculated intervention travel control amount is output to the motion control function part 30.

Basically, the motion control function part 30 calculates the travel control amount of the vehicle M1 such that the vehicle M1 follows the target trajectory. However, when the intervention travel control amount is input from the preventive safety function part 40, the motion control function part 30 corrects the travel control amount based on the intervention travel control amount input from the preventive safety function part 40. Typically, when the intervention travel control amount is input from the preventive safety function part 40, the motion control function part 30 outputs the intervention travel control amount as the final travel control amount.

### 1-8. Operation Involvement Calculation Process

The driving involvement degree is calculated, for example, in the first unit 10. Typically, the first unit 10 calculates a driving involvement degree based on the automated driving information. When the automated driving information indicates whether the target trajectory generation process is executed, the first unit 10 calculates the driving involvement degree in the case where the target trajectory generation process is executed to a value lower than that in the case where the target trajectory generation process is not executed.

Alternatively, when the automated driving information includes information regarding override determined from the operation amount of the travel device 26, the first unit 10 calculates the driving involvement degree when the override is being executed to a value higher than that when not executed.

Alternatively, the first unit 10 calculates the driving involvement degree based on the driving environment information 140. The driving environment information 140 includes an index of a consciousness level detected by the driver state sensor 145. When it is determined from the driving environment information 140 that the consciousness level of the driver is lowered due to looking aside or falling asleep, the first unit 10 calculates the driving involvement degree to be lower than that in the case where the consciousness level of the driver is not determined. The first unit 10 executes such driving involvement degree calculation process in a predetermined control period. The driving involvement degree calculated in the first unit 10 is output to the second controller 22 from time to time.

Alternatively, the driving involvement degree is calculated in the second unit 20 based on, for example, the automated driving information output from the first unit 10. Typically, when the automated driving information is information representing ON/OFF of the first unit 10, the second unit 20 calculates the operation involvement when the first unit 10 is ON, lower than that when it is OFF. When the automated driving information is information indicating whether the target trajectory of the first unit 10 is generated, the second unit 20 calculates the driving involvement degree when the target trajectory is generated (for example, when the valid value is output) to be lower than that when the target trajectory is not generated (for example, when the invalid value is output). Alternatively, when the automated driving information is the target trajectory of the first unit 10, the second unit 20 calculates the driving involvement degree higher as the degree of coincidence between the target trajectory and the behavior of the vehicle M1 is lower.

When the driver information is included in the driving environment information 240, the second unit 20 may calculate the driving involvement degree based on driver information. Alternatively, the second unit 20 may receive the driving environment information 140 from the first unit 10, and calculate the driving involvement degree based on the driver information included in the driving environment information 140.

### 1-9. Specifically Processing of Intervention Degree Change Control

The second controller 22 of the present embodiment changes the intervention degree based on the automated driving information in the preventive safety control during the automated driving.

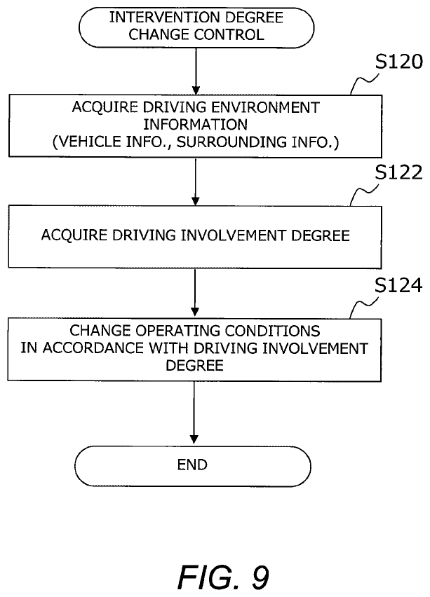

FIG. 9 is a flowchart showing a control routine of the intervention degree change control executed by the second controller 22. The second controller 22 repeatedly executes the routine shown in FIG. 9 at a predetermined control period during the automated driving of the vehicle M1.

When the routine shown in FIG. 9 is started, the second controller 22 acquires the driving environment information 240 (the vehicle information and the surrounding situation information) from the second information acquisition device 24, in step S120. The acquired information is stored in the second memory device 224.

Next, in step S122, the second controller 22 acquires the driving involvement degree from the first unit 10. The acquired operation involvement degree is stored in the second memory device 224.

Next, in step S124, the second controller 22 changes the operating conditions of the preventive safety control in accordance with the driving involvement degree. Here, the operating condition of the preventive safety control for the avoidance target recognized based on the driving environment information 240 is changed. Typically, the second controller 22 changes the threshold of the TTC (Time To Collision) for the avoidance target such that the operation timing of the preventive safety control becomes earlier as the driving involvement degree is lower.

As described above, according to the vehicle control system 100 of the first embodiment, it is possible to determine whether the operating condition of the preventive safety control should be changed by using the driving involvement degree. As a result, it is possible to suppress the intervention of the preventive safety control in a situation where the driver feels uncomfortable or anxious, and to enhance the safety in a situation where the driver does not easily feel uncomfortable or anxious.

### 1-10. Modification Examples

The vehicle control system 100 according to the first embodiment may be applied with a configuration modified as described below.

The driving involvement degree may be calculated in the second unit 20 based on the automated driving information received from the first unit 10. In addition, the driving involvement degree may be calculated in the second unit 20 based on the driving environment information received by the second unit 20.

The preventive safety function part 40 may have a function of calculating a target trajectory instead of a function of calculating an intervention travel control amount. The target trajectory calculated by the preventive safety function part 40 is hereinafter referred to as an “intervention target trajectory”. In this case, the calculated intervention target trajectory is output to the motion control function part 30. When the intervention target trajectory is input from the preventive safety function part 40, the motion control function part 30 may calculate the travel control amount based on the intervention target trajectory.

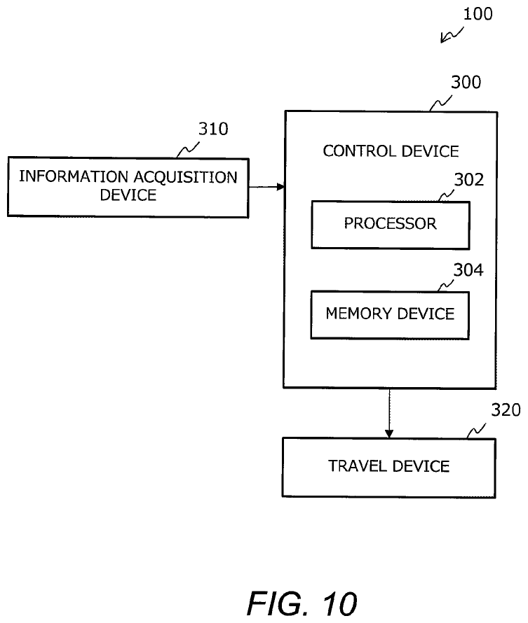

The first controller 12 and the second controller 22 may be configured as a single common controller. FIG. 10 is a diagram showing a modification of the configuration of the vehicle control system according to the present embodiment. The vehicle control system 100 includes a controller 300, an information acquisition device 310, and a travel device 320. The information acquisition device 310 includes the same functions as the first information acquisition device 14 and the second information acquisition device 24. The travel device 320 includes the same function as the travel device 26.

The controller 300 includes both functions as the first controller 12 of the first unit 10 and a function as the second controller 22 of the second unit 20. The controller 300 includes a processor 302 and a memory device 304. The processor 302 executes the automated driving control software and the vehicle driving control software, which are computer programs. Each software is stored in the memory device 304. Alternatively, each software is recorded on a computer readable recording medium. That is, in the modification of the vehicle control system 100 shown in FIG. 10, the functions of the first controller 12 and the second controller 22 are realized by the processor 302 executing these software.

The method of changing the intervention degree in the intervention degree change control is not limited. That is, the second controller 22 is not limited to changing the operation threshold value of the preventive safety control and changing the operation timing, and may be configured to change the intervention degree by changing the operation amount by the preventive safety control. The modified configurations may also be applied as appropriate within a scope of the present disclosure.

The first unit 10 and the second unit 20 may be separately designed and developed. For example, the second unit 20 responsible for vehicle travel control is designed and developed by a developer (typically an automobile manufacturer) familiar with the mechanics and vehicle motion characteristics. In this case, reliability of the preventive safety function part 40 of the second unit 20 is extremely high. On the premise of utilizing the high-reliability preventive safety function part 40, an automated driving service provider can design and develop software for the first unit 10. In that sense, it can be said that the second unit 20 is a platform for automated driving services.

What is claimed is:

1. A vehicle control system that controls a vehicle capable of performing automated driving, the vehicle control system comprising:
a first unit configured to generate a target trajectory for the automated driving based on a travel plan of the vehicle; and
a second unit configured to execute vehicle travel control that controls steering, acceleration, and deceleration of the vehicle such that the vehicle follows the target trajectory,
wherein, during the automated driving, the second unit is configured to control a travel control amount which is a control amount of the vehicle travel control, acquire driving environment information indicating a driving environment around the vehicle, and perform preventive safety control for intervening in the travel control amount so as to prevent or avoid a collision between the vehicle and an obstacle based on the driving environment information, and
wherein, in the preventive safety control, the second unit is configured to acquire a driving involvement degree indicating a degree of involvement of a person in driving of the vehicle, and to change an intervention degree to the travel control amount in the preventive safety control based on the driving involvement degree.

2. The vehicle control system according to claim 1,
wherein, in the preventive safety control, when the driving involvement degree is low, the second unit is configured to change the intervention degree so as to accelerate an operation timing of the preventive safety control as compared with a case where the driving involvement degree is high.

3. The vehicle control system according to claim 1,
wherein, the first unit is configured to calculate the driving involvement degree based on automated driving information related to the automated driving, and transmit the driving involvement degree to the second unit.

4. The vehicle control system according to claim 3,
wherein, the automated driving information includes whether the target trajectory is generated, and
wherein, the first unit is configured to calculate the driving involvement degree as a lower value when the target trajectory is generated than when the target trajectory is not generated.

5. The vehicle control system according to claim 3,
wherein, the automated driving information includes an operation amount of a travel device of the vehicle by a person, and
wherein, the first unit is configured to calculate the driving involvement degree based on the operation amount.

6. The vehicle control system according to claim 1,
wherein, the first unit is configured to transmit automated driving information related to the automated driving to the second unit, and
wherein, the second unit is configured to calculate the driving involvement degree based on the automated driving information acquired from the first unit.

7. The vehicle control system according to claim 6,
wherein, the automated driving information includes the target trajectory, and
wherein, the second unit is configured to calculate the driving involvement degree as a higher value when the target trajectory is an invalid value than when the target trajectory is a valid value.

8. The vehicle control system according to claim 6,
wherein, the automated driving information includes the target trajectory, and
wherein, the second unit is configured to calculate the driving involvement degree based on a degree of agreement between the target trajectory and a current behavior of the vehicle.
